(19) United States
(12) Patent Application Publication
(10) Pub. No.: US 2010/0017609 A1
(43) Pub. Date: Jan. 21, 2010

(54) METHOD AND DEVICE FOR CONTROLLING AND MANAGING COMPRESSED AND FREELY DOWNLOADED MULTIMEDIA FILES

(75) Inventor: Alain Rosset, Lyon (FR)

Correspondence Address: HARNESS, DICKEY & PIERCE, P.L.C., P.O. BOX 828, BLOOMFIELD HILLS, MI, 48303, US

(73) Assignee: UBICMEDIA, Lyon (FR)

(21) Appl. No.: 12/520,801

(22) PCT Filed: Dec. 19, 2007
(86) PCT No.: PCT/FR07/02116

§ 371 Date: Aug. 26, 2009

(30) Foreign Application Priority Data
Dec. 29, 2006 (FR) 0611493

(51) Int. Cl. G06F 21/00; H04L 9/00

(52) U.S. Cl. 713/168; 726/26

(57) ABSTRACT

The present invention relates to a method for controlling the distribution and use of digital multimedia files composed of binary data blocks according to an original format, and separated into at least two parts, characterised in that it includes a step of transmission, from a server of utilisation conditions, of the preferred parameters for the reconstruction of the whole or a part of said original file on a terminal.

The invention also relates to a device for the controlled distribution and use of digital multimedia files separated into at least two parts with a view to implementing the method according to any one of claims 1 to 19, including at least one server for the preferred parameters and one server for the reconstruction and characterised in that it includes a device for transmitting said preferred parameters and for the reconstruction of the whole or a part of said original file on any terminal.

### CROSS-REFERENCE TO RELATED APPLICATIONS

This application is a National State Entry of International Application No. PCT/FR2007/002116, filed on Dec. 19, 2007, which claims priority to French Patent Application No. 0611493, filed on Dec. 29, 2006, both of which are incorporated by reference herein.

### BACKGROUND AND SUMMARY

The present invention relates to the free circulation of any audiovisual and multimedia file and content and provides a method and a system for the free circulation, the control and the follow-up of each utilisation or consumption of audiovisual and multimedia files and contents on any telecommunication network.

The general issue is to provide a device capable of circulating freely and of having a controlled consumption, by authorised users, of compressed digital audiovisual and multimedia files, for example of the MPEG type for video, of the JPEG type for still images or MP3 type for audio, on any type of telecommunication or computer network, without this list being limitative. With the present solutions, it is possible to transmit multimedia contents in a digital form via any type of network. To avoid the hacking of the thus diffused streams, two techniques for transmitting these contents exist. According to a first technique, they are either encrypted by various means which are well known to the persons skilled in the art. According to a second technique, they are transmitted in the form of streams in client/server mode. However, these two transmission techniques have advantages and drawbacks which are not simultaneous.

As regards the first technique, solutions based on an encryption are provided, such as the one described in the application for the US patent 2002/108035 aiming at limiting the duration and useless repetition of the encryption of a whole file having a different decryption key. Therefore, it provides a method for partially encrypting a data file including a step of dividing a data file into a first file and a second file, with the second file containing a part of the content of the original data file to prevent the reconstruction of the original data file from the first file only and a step for encrypting the second file. The main drawback of such encryption solutions is that not only the encrypted contents must be transmitted to the users but also the decryption keys and the utilisation licenses to a terminal identified and authentified by the user, so as to enable the execution of said contents. Thus, the necessity exists to implement rights management systems DRM based on the issuing of licenses.

In the state of the art is more particularly known the “Windows Media DRM” system which enables the digital management of the multimedia content rights on a network. This system further implements authorisation, authentication and encryption techniques for enabling a user to consult a protected content from a terminal via a network. Customised licenses are then implemented via encryption keys and certifications of the reading device.

Solutions complying with this system are extremely efficient but they are also extremely constraining for the user and the owner. In the absence of very efficient license and/or encryption, the contents are generally thus decrypted. In addition, the utilisation of the file and the content thereof depends on the licensed terminal and the authentication thereof. The licensed management such as performed in the conventional DRM and which induces an important complexity for the owner and the user is not required in the method according to the present invention.

A second technique based on the transmission of streams partly remedies the drawback of the first technique described hereabove, but has several drawbacks, among which the requirement for the transfer of the whole digital file upon each utilisation, and a connection by the user to the server via a generally high bandwidth connection. If said digital file is heavy, for example a very high quality digitalised audiovisual file, the owner will reach only the users which are well serviced by large bandwidth connections. The result is that the servers and the transport networks systematically and quickly reach their saturation level. If said connection rate is too low, the file and the content thereof lose all their market values for the owner without, however, eliminating the same drawbacks related to the bandwidth. More particularly, each utilisation requires the total transfer of the file and the content thereof. In addition, the utilisation thereof depends on the site where it is broadcast from.

Finally, these two techniques have other major drawbacks. The first one is that they are not able to authorise the transfer of the file without control. The second is that the utilisation of said file, broadcast or transferred from one user to another user, is not controlled.

In order to correct these various defects, the invention, in its broadest sense, relates to a method for controlling the distribution and the use of digital multimedia files composed of binary data blocks according to an original format, and separated into at least two parts, characterised in that it includes a step of transmission, from a server of the utilisation conditions, of the preferred parameters for the reconstruction of the whole or a part of said original file on a terminal. In a particular embodiment, said two parts are composed of a first modified file having the format of the original file and a complementary file having any format including information on the modifications brought to said original file.

Advantageously, said preferred embodiment can be modified at any time by the owner. Advantageously, said step of transmitting the preferred parameters is carried out through an authorisation server and through a telecommunication network. Advantageously, said step of transmission of the preferred parameters is carried out upon said reconstruction. Advantageously, said preferred parameters are defined by utilisation parameters. Advantageously, said preferred parameters relate to one part only of said original file. Advantageously, said preferred parameters relate to a limited period.

Advantageously, said preferred parameters are valid for only one part of said terminals. Advantageously, said preferred parameters are linked to a transaction. Advantageously, said preferred parameters can be modified at will. Advantageously, said preferred parameters can be deleted at any time.

In another particular embodiment, said complementary file is transmitted to said terminal after the authorisation by said authorisation server. In another embodiment, said complementary file is transmitted to said terminal through a channel encrypted with a temporary key.

Advantageously, said temporary key is calculated by an application in said authorisation server. Advantageously, said temporary key is transmitted to the server of the complementary files. Advantageously, said temporary key is transmitted to said terminal. Advantageously, said temporary key is transmitted through the server of the complementary files. Advantageously, the existence of said temporary key lasts for only the time of said transfer.

Finally, the invention also relates to a device for the controlled distribution and use of digital multimedia files separated into at least two parts with a view to implementing the method and including at least a server of the preferred parameters and a server for the reconstruction, and characterised in that it includes a device for transmitting said preferred parameters and reconstruction parameters for the whole or part of said original file on any terminal. The invention enables a total control of all the utilisations and the utilisation conditions of the copies of the files and the audiovisual and multimedia contents thus circulated or broadcast. Said conditions are given by the owner of the rights on the original content. The invention also makes it possible for said owner of the rights to modify the conditions of utilisation at any time, including of the contents and files already broadcast. The owner can also definitely delete any utilisation of a content, including the utilisation of contents and files already broadcast or saved.

### BRIEF DESCRIPTION OF DRAWINGS

The present invention will be best understood when reading the description of a non limitative exemplary embodiment, and referring to the appended drawings, wherein:

FIG. 1 describes the assembly architecture of a system for implementing the method according to the invention;

FIG. 2 describes the architecture of the portal and the servers of data according to the invention; and

FIG. 3 shows a particular embodiment of a receiving terminal according to the invention.

### DETAILED DESCRIPTION

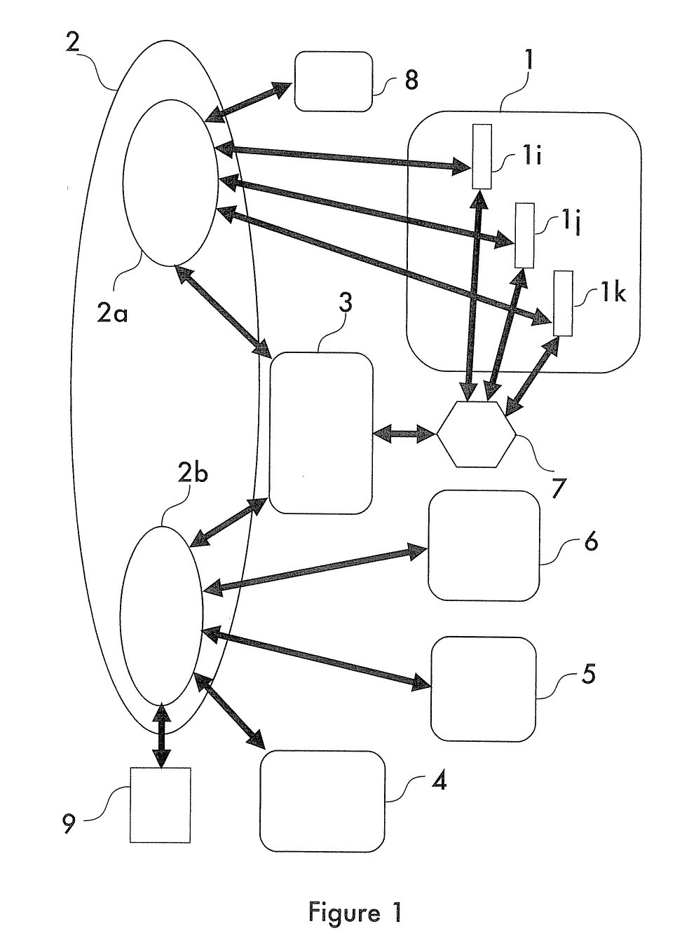

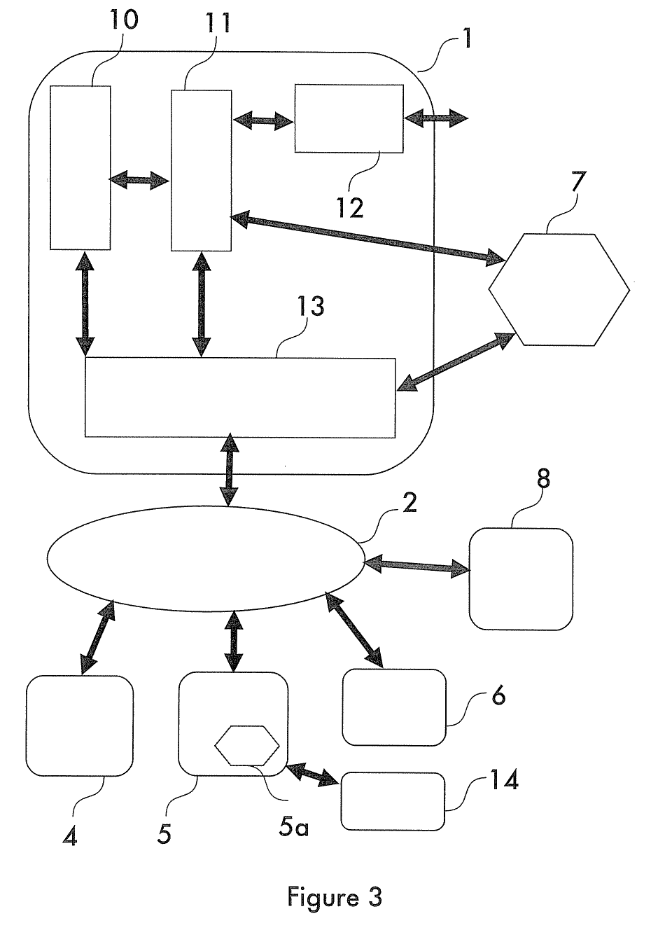

In FIG. 1, when the user of a terminal 1: 1i, 1j, 1k, etc. wishes to view an audiovisual content available on a physical medium 7 or a server 8 or on a storage 10 of its terminal of FIG. 3, it makes a request to the portal 3 through said telecommunication network 2a. Said portal then decides, as a function of the operational parameters supplied by the owner 9 of the rights to broadcast the content and stored in the server 5 of the utilisation conditions, to send or not to send the complementary elements stored in the server 4 and corresponding to this audiovisual and multimedia content, through the networks 2b. Information on the follow-up of the utilisations requested by said owner 9 for editing purposes is stored on the follow-up server 6.

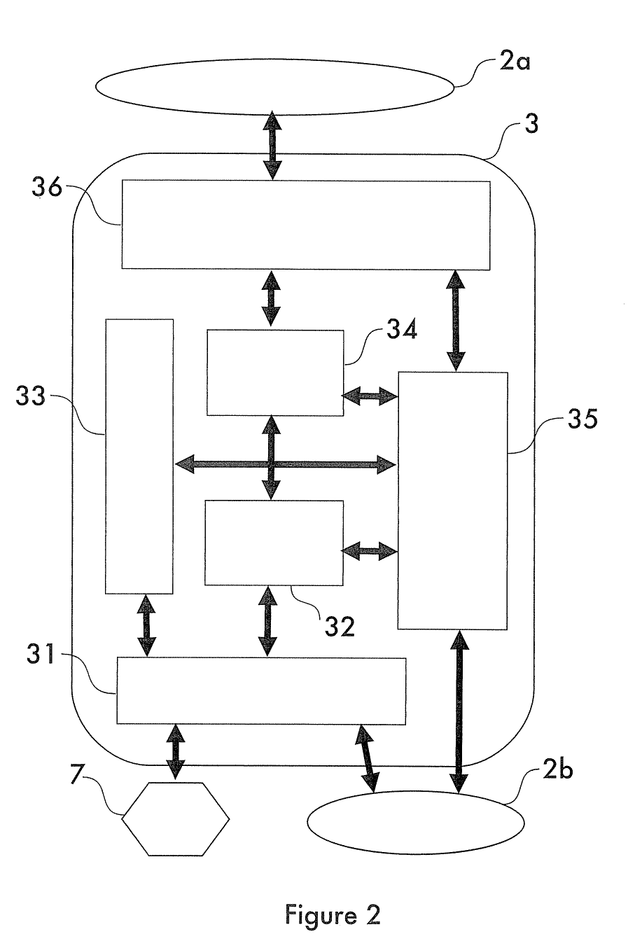

Prior to this phase, the original audiovisual and multimedia content 31 supplied by an owner 9 in the downloading 2b or on a physical medium 7 will be prepared by the portal 3 as shown in FIG. 2. Each audiovisual file 31 is shown in a compressed digital form and is composed of binary data blocks, resulting from digital transformations applied to an audiovisual and multimedia content according to an original file format. The original format of an original content 31, for example a file having an original MPEG-2, MPEG-4 or H264 format for video, or an original MP3 or AAC format in the case of audio files, or an original JPEG format in the case of still images or photographic files.

In a first step, the original content 31 is separated into at least two parts, among which a first modified file 32 having the format of the nominal original file and into a complementary file 33 having any format including information on the modification brought to said original file 31. The reconstruction of the original file 31 cannot be carried out but from both files 32 and 33 but not from one of them only.

During a second step and through a portal 3 and through a telecommunication network 2b, said owner 9 supplies the parameters management system 35 its preferences as regards the economic and marketing conditions of the reconstitution of said original file on any terminal 1: 1i, 1j, 1k, etc. by any user who wishes to read, listen to or see the content of the original file. Said preferences are defined by the utilisation parameters which can be of any kind and more particularly:

free to be used during a limited period or an unlimited period by any user or only by dedicated users (for example, countries, member of an intranet or an extranet, etc.),

payment upon each utilisation,

subscription to a certain number of utilisation for a limited or unlimited period,

subscription for a determined period with or without limit on the number of utilisation,

free but linked to a transaction as for example against information on the user: name, email, company, function, utilisation condition etc.,

free authorisation for one or several extract or extracts (for example, teasing, etc.),

free authorisation for the first reading or starting from the nth reading, etc.,

free authorisation or reduced price authorisation against the playing of advertising contents,

with “url pointer” on the original site of the content where the contexts and/or the explanations are given on this content or for any other reasons,

with or without the display of a copyright and/or a sub-title,

with the integration of keywords for the marking, or “tagging” system by third parties,

etc.

Such operational parameters are stored on a server 5 of the utilisation conditions by the portal 3 management system 35. The owner also provides its preferences for editing purposes during this same step. These follow-up parameters can be of any kind and more particularly:

user's country or region,

rate noted during the utilisation,

dates and times of the beginning and the end of the utilisation,

the mistakes made during the utilisation or during the authorisation mechanism,

the utilisation of the video recorder keys during the utilisation,

the reasons for the refusal of a request for authorisation,

the abandon of a user during the authorisation mechanism,

the confirmation of a correct utilisation,

the progressive mode playing,

etc.

These so-called follow-up parameters are stored on said follow-up servers 6 by the portal 3 management system 35.

During a third step, the servers for 4, 5 and 6 references where are respectively stored the complementary file 33 of the original content and all the associated parameters are integrated into the meta-data of the modified file 32 for obtaining a mobile modified file 34. Upon completion of these steps of processing the audiovisual and multimedia contents, said mobile modified files 34 are freely transmitted and broadcast to the terminals 1 through said telecommunication network 2a via the interface 36.

In a particular exemplary embodiment, said mobile modified files 34 are freely transmitted and broadcast by any exchange network like, for example, a community network, a blog network, a social network or a P2P network. In another example, said mobile modified files 34 are freely transmitted and broadcast by physical media 7 like for example DVDs, CD-ROMs or any other storage of the USB or hard disk types, etc. Advantageously, said mobile modified files 34 are freely transmitted and broadcast on one or several conventional audiovisual and multimedia servers 8. The multimedia content are now available for the users 1: 1i, 1j, 1k, etc. through said mobile modified files 34, and controlled by the owner's parameters stored in the servers 5 of the utilisation conditions as shown in FIG. 3.

A mobile modified file is then available for the user 1: 1i, 1j, 1k on a mass storage 10 of his or her terminal or on an external medium 7 like a DVD, a CD-ROM, a USB key, etc., or through the downloading from the server 8 or from another terminal 1 though the transfer on the Internet or provided with a client/server software, or P2P, etc. When the user 1 wants to use the mobile modified file 34, the latter is either played on the hard disk 10, the DVD or a CD 7 on his or her terminal, or downloaded onto his or her terminal through his or her interface 13. Whatever the user's connection rate, specific software 11 for the player adapted to the format of the original file is downloaded automatically or upon the user's request, or is already available on his or her terminal or integrated in an html window or as an autonomous application on the terminal. Said specific software 11:

reads the meta-data of the mobile modified file 34, more particularly the identification of the content and the owner and the reference of the servers 4, 5 and 6, which are managed by the system provided,

sets up a client/server connection with the server of the complementary files 4 managed by the system provided, the references of which are noted in said meta-data,

and transmits the owner's identifications and the content of the mobile modified file 34 to said server.

Said server of the complementary files 4 interrogates the server 5 of the utilisation conditions and implements the owner's utilisation conditions for this mobile modified file. The following steps are then executed:

transmission of the “url” address of the server 14 to the software 11. Said server 14 is for example an LD for requesting marketing information, online payment, subscription management, etc. Advantageously, said server 14 is that of the provided system or that of the owner or of a third party. Advantageously, said server 14 is also used as an authorisation server. Advantageously, said server 14 is also used as an identification server.

said identification server 14 transmits the authorisation or the absence of authorization for the operation of the mobile modified file by the user,

said server 5 of the utilisation conditions transmits to the software 11 the authorisation to operate the mobile modified file 34 through said complementary files server 4,

if the authorisation is denied, the software 11 plays the downloaded file without the information of the complementary file, thus in a way which is indiscernible by the user,

if the authorisation is granted, the software 11 plays the downloaded file and simultaneously receives from the complementary files server 4 the complementary file for reconstructing the original file on the user's terminal,

the events such as listed in the above-mentioned follow-up parameters are transmitted by the software 11 to said follow-up server 6 by said complementary files server 4.

More particularly, the user of the terminal 1 consults a menu or a server 8 via his or her interface 12. Said user selects the contents he or she wishes to consume and the mobile modified file 34 corresponding to this content is transmitted by the server 8 to the terminal 1. Said interface 12 is for example connected to a screen, to loudspeakers, to a keyboard, to a mouse, etc. Said mobile modified file 34 is recorded via the interface 13 of FIG. 3 in the storage 10 composed for a hard disk or any other type of mass storage.

As from the beginning of the connection between said terminal 1 and said server 8, the player 11 plays the meta-data of said mobile modified file 34, more particularly the reference of said complementary file 33 of said complementary file server 4. Said terminal 1 then connects to said complementary files server 4 in client/server mode. Said complementary files server 4 converses with said utilisation conditions server 5 and then checks that said user 1 has been granted the authorisations to consume said modified multimedia file 34 and takes all necessary measures so that the utilisation conditions supplied by said owner 9 are complied with. Said complementary files server 4 then transmits in a synchronised way the elements of the complementary file 33 to the player 11 of the terminal of said user 1 which reconstructs a synthesis of the original audiovisual file, from the calculation of the receiving terminal 1, as a function of said mobile modified file 34 and the elements of said complementary file 33. Said synthesis of the original audiovisual content is then displayed on the screen via the interface 12.

Advantageously, said synthesis of the reconstructed contents is carried out as soon as the first information on said modified multimedia file 34 and the first elements of said complementary file 33 are received. Advantageously, said synthesis of the reconstructed content is recorded under the control of said complementary file server 4, in the storage 10 of the terminal 1. Advantageously, said synthesis of the reconstructed contents is marked with a tattooing system.

Advantageously, said synthesis of the reconstructed contents is recorded under the control of said complementary file server 4 on a physical medium 7 like a DVD, a CD-ROM, a USB storage, etc. Advantageously, the user of the terminal 1i transmits a copy of said mobile modified file 10 or 7 to another terminal 1: 1i, 1j, 1k, etc. Advantageously, the events connected to the follow-up of the utilisation of the mobile modified file 34 by the user 1 are transmitted through said complementary files server 4 to said follow-up server 6 referenced in the meta-data of the mobile modified file 34.

Each utilisation of a mobile modified file, whether authorised or not, is thus recorded in said follow-up server 6 according to the condition parameters requested by the owner thereof and managed by the servers 5 and 6. The owner can consult the tracks of the utilisation managed by said follow-up server 6 at any time through the management system 35 of the portal 3 and make statistics he requires for his editorial chart system. It can more particularly change the operational parameters stored in said utilisation conditions servers 5 can be changed at any time, of any mobile modified file 34 inclusive of those already broadcast mobile modified files.

Advantageously, the transfer of the complementary file 33 to the terminal of a user 1 and when the utilisation of the contents 34 is authorised for said user 1, is carried out for a channel encrypted with a temporary key. Advantageously, said temporary key is calculated by an application 5a executed by said server 5 of the utilisation conditions. Said temporary key is then transmitted by said server 5 of the utilisation conditions to the player 11 and to said complementary files server 4 in a synchronised manner. Advantageously, the validity of said temporary key lasts only for the time required for said transfer.

In another particular embodiment, whatever the reasons, said original file which must no longer be operated in the way mentioned hereabove, is deleted by simply deleting the corresponding complementary file 33 in said complementary files server 4, even though the corresponding mobile modified file has already been broadly broadcast via the networks.

1. A method for controlling the distribution and use of digital multimedia files comprised of binary data blocks according to an original format and separated into at least two parts, the method comprising transmitting, from a server of the utilisation conditions, of the preferred parameters for the reconstruction of the whole or part of said original file on a terminal.

2. A method for controlling the distribution and use of digital multimedia files separated into at least two parts according to claim 1, wherein said two parts are comprised of a first modified file having the format of the original file and a complementary file having any format including information on the modifications brought to said original file.

3. A method for controlling the distribution and use of digital multimedia files separated into at least two parts according to claim 1, further comprising modifying said preferred parameters at any time by an owner thereof.

4. A method for controlling the distribution and use of digital multimedia files separated into at least two parts according to claim 1, further comprising carrying out said step of transmission of the preferred parameters through an authorisation server and through a telecommunication network.

5. A method for controlling the distribution and use of digital multimedia files separated into at least two parts according to claim 1, further comprising carrying out said step of transmission of the preferred parameters upon said reconstruction.

6. A method for controlling the distribution and use of digital multimedia files separated into at least two parts according to claim 1, further comprising defining said preferred parameters by used parameters.

7. A method for controlling the distribution and use of digital multimedia files separated into at least two parts according to claim 1, wherein said preferred parameters concern one part of said original file.

8. A method for controlling the distribution and use of digital multimedia files separated into at least two parts according to claim 1, wherein said preferred parameters concern a limited period.

9. A method for controlling the distribution and use of digital multimedia files separated into at least two parts according to claim 1, wherein said preferred parameters are valid only for one part of said terminals.

10. A method for controlling the distribution and use of digital multimedia files separated into at least two parts according to claim 1, further comprising linking said preferred parameters to a transaction.

11. A method for controlling the distribution and use of digital multimedia files separated into at least two parts according to claim 1, further comprising modifying said preferred parameters at will.

12. A method for controlling the distribution and use of digital multimedia files separated into at least two parts according to claim 1, further comprising deleting said preferred parameters at any time.

13. A method for controlling the distribution and use of digital multimedia files separated into at least two parts according to claim 1, further comprising transmitting said complementary file to said terminal after the authorisation from said authorisation server.

14. A method for controlling the distribution and use of digital multimedia files separated into at least two parts according to claim 1, further comprising transmitting said complementary file to said terminal through a channel encrypted with a temporary key.

15. A method for controlling the distribution and use of digital multimedia files separated into at least two parts according to claim 14, further comprising calculating said temporary key by an application in said authorisation server.

16. A method for controlling the distribution and use of digital multimedia files separated into at least two parts according to claim 13, further comprising transmitting said temporary key to the server of the complementary files.

17. A method for controlling the distribution and use of digital multimedia files separated into at least two parts according to claim 13, further comprising transmitting said temporary key to said terminal.

18. A method for controlling the distribution and use of digital multimedia files separated into at least two parts according to claim 13, further comprising transmitting said temporary key through a server of the complementary files.

19. A method for controlling the distribution and use of digital multimedia files separated into at least two parts according to claim 13, wherein the existence of said temporary key lasts only for the time of said transfer.

20. A method for controlling the distribution and use of digital multimedia files separated into at least two parts with a view to implementing the method according to claim 1, further comprising at least one server of the preferred parameters and one server for the reconstruction, and a device operably transmitting said preferred parameters and for the reconstruction of the whole or a part of said original file on any terminal.
